(19) United States
(12) Patent Application Publication
(10) Pub. No.: US 2008/0075345 A1
(43) Pub. Date: Mar. 27, 2008

(54) Method and System For Lymph Node Segmentation In Computed Tomography Images

(75) Inventors: Gozde Unal, Plainsboro, NJ (US); Atilla Peter Kiraly, Plainsboro, NJ (US); Gregory G. Slabaugh, Princeton, NJ (US); Carol L. Novak, Newtown, PA (US); Tong Fang, Morganville, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS CORPORATION RESEARCH, INC., PRINCETON, NJ (US)

(21) Appl. No.: 11/857,801

(22) Filed: Sep. 19, 2007

Related U.S. Application Data
(60) Provisional application No. 60/826,253, filed on Sep. 20, 2006.

(51) Int. Cl. G06K 9/62

(52) U.S. Cl. 382/131

(57) ABSTRACT

A method and system for lymph node segmentation in computed tomography (CT) images is disclosed. A location of a lymph node in a CT image slice is received. Intensity constraints are determined based on a histogram analysis of the CT image slice, and a spatial analysis of the intensity constrained CT image slice is performed using edge detection. An initial contour is estimated based on the lymph node location and the spatial analysis. The lymph node is then segmented by propagating the initial contour using an evolving elliptical model to define the lymph node boundaries.

This application claims the benefit of U.S. Provisional Application No. 60/826,253, filed Sep. 20, 2006, the disclosure of which is herein incorporated by reference.

### BACKGROUND OF THE INVENTION

The present invention relates to lymph node segmentation in computed tomography (CT) images, and more particularly, to an automated lymph node segmentation using an evolving elliptical model contour.

Humans have approximately 500-600 lymph nodes, which are important components of the lymphatic system. Lymph nodes act as filters to collect and destroy cancer cells, bacteria, and viruses. Radiologists examine the lymphatic system for cancer staging (i.e., diagnosing the extent or severity of a patient's cancer) and evaluation of patient progress in response to treatment. Such examination of the lymphatic system involves finding specific lymph nodes, labeling them, and assessing the condition of the lymph nodes both initially and as a follow-up in a later image. This assessment typically consists of measuring major and minor radii of the lymph node to determine if they fall into normal limits. The measurement of the major and minor radii, in effect, fits an ellipse to the lymph node. Recently, contrast-enhanced CT images have gained popularity in evaluating lymph nodes.

Lymph node staging is a process of grouping lymph nodes into particular categories to determine the extent of cancer and the response to treatment. For example, within the lungs, lymph nodes are classified as N1, N2, or N3 based upon their location in relation to the primary lung cancer. This process can be tedious when performed manually. Accordingly, computer assistance is desirable to assist with lymph node staging.

One opportunity for computer automation of the lymph node staging process involves automatically locating and labeling the lymph nodes. This can be useful in finding the lymph nodes in CT images and matching lymph nodes in original and follow-up images. One such method for automated lymph node labeling and localization uses anatomic features within the image to determine specific labels and locations of lymph nodes.

### BRIEF SUMMARY OF THE INVENTION

The present invention addresses the automated evaluation of lymph nodes. Embodiments of the present invention are directed to segmenting a lymph node in a computed tomography (CT) image given its location. This capability offers a basis for automated measurements and analysis of lymph nodes, which can lead to more consistent measurements among users along with faster-evaluation times.

In one embodiment of the present invention, a lymph node location in a CT image slice is received. Intensity constraints are determined based on a histogram analysis of the CT image slice, and an edge analysis of the intensity constrained CT image slice is used to estimate an initial contour. The lymph node is then segmented by propagating the initial contour using an evolving elliptical model to define the lymph node boundaries.

These and other advantages of the invention will be apparent to those of ordinary skill in the art by reference to the following detailed description and the accompanying drawings.

### BRIEF DESCRIPTION OF THE DRAWINGS

FIG. 1 illustrates a method for segmenting a lymph node in a CT image according to an embodiment of the present invention;

FIG. 2 illustrates an exemplary 2D CT image slice;

FIG. 3 a method for determining intensity constraints based on a histogram analysis according to an embodiment of the present invention;

FIG. 4 illustrates a histogram showing the probability density function of the CT image slice of FIG. 2;

FIG. 5 illustrates a lymph node density range on the histogram of FIG. 4;

FIG. 6 illustrates a normalized image of the CT image slice of FIG. 2;

FIG. 7 illustrates an edge map of the normalized image of FIG. 6;

FIG. 8 illustrates a Hough measure as a function of the radius of the initial contour;

FIG. 9 illustrates an exemplary CT image slice showing an initial contour;

FIG. 10 illustrates exemplary segmentation results;

FIG. 11 illustrates an exemplary CT image analysis system; and

FIG. 12 is a high level block diagram of a computer capable of implementing the present invention.

### DETAILED DESCRIPTION

The present invention is directed to a method for lymph node segmentation in computed tomography (CT) images. Embodiments of the present invention are described herein to give a visual understanding of the lymph node segmentation method. A digital image is often composed of digital representations of one or more objects (or shapes). The digital representation of an object is often described herein in terms of identifying and manipulating the objects. Such manipulations are virtual manipulations accomplished in the memory or other circuitry/hardware of a computer system. Accordingly, is to be understood that embodiments of the present invention may be performed within a computer system using data stored within the computer system.

Embodiments of the present invention are directed to segmenting lymph nodes within 3D CT images given a specific lymph node location. Accordingly, given such a location of lymph node, embodiments of the present invention provide a method that extracts the lymph node borders in a CT image slice using a parametric active contour that is initialized and propagated based on intensity and spatial analysis. Embodiments of the present invention can be applied to segment lymph nodes in contrast-enhanced CT images, as well as non-contrast enhanced CT images.

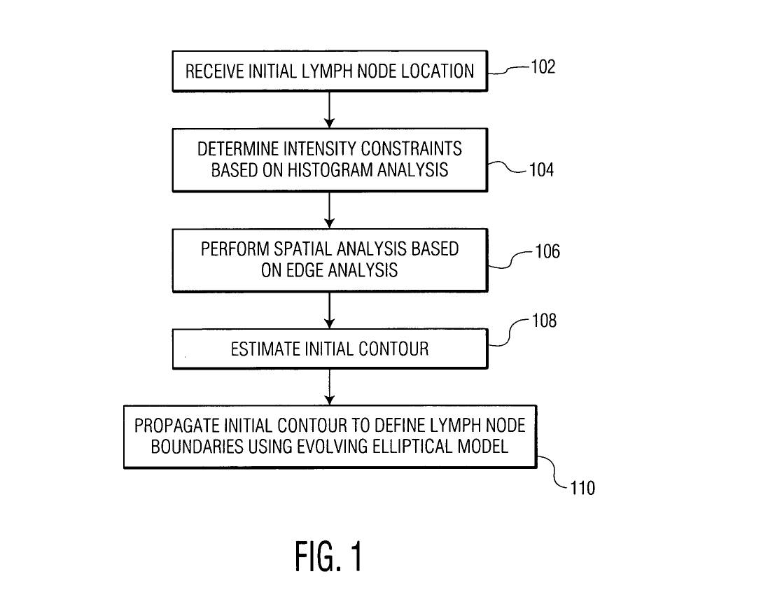

FIG. 1 illustrates a method for segmenting a lymph node in a CT image according to an embodiment of the present invention. At step 102, an initial lymph node location is received. For example, a user, such as a radiologist, can click on a point in a CT image with a mouse or other user input device to input a location of a lymph node into a computer system. It is advantageous that the initial lymph node location be a point within a CT image slice at or near the center or thickest portion of the lymph node. This is not difficult for radiologists since they frequently navigate to this portion of the lymph node and locate the center of the lymph node using well-known techniques. The lymph node location received can be referred to as a point (x₀,y₀,z₀) in the 3D CT image. This method operates on the 2D CT image slice at z=z₀. Accordingly, this point is referred to as (x₀,y₀) within the 2D CT image slice I hereinafter. Although the initial lymph node location is described in this step as being received via a user input, it is possible that the initial lymph node location be input automatically, for example, as a result of an automatic lymph node localization method.

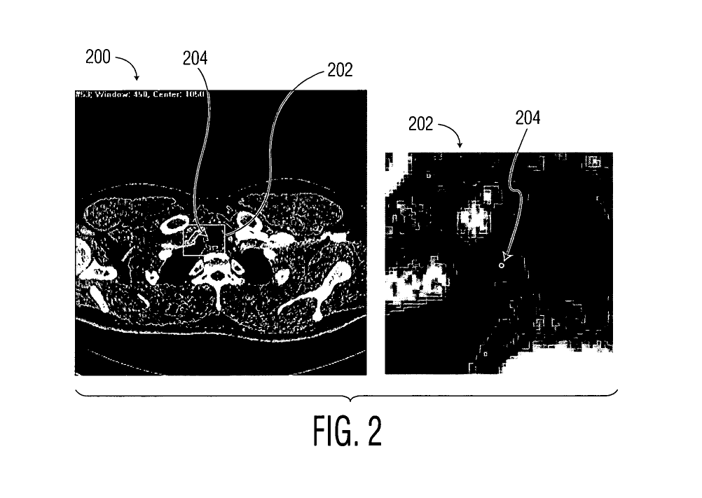

FIG. 2 illustrates an exemplary 2D CT image slice/(200). As illustrated in FIG. 2, an initial lymph node location 204 is marked on the CT image slice 200. Shown to the right of the CT image slice 200 is a zoomed in image of region 202 of the CT image slice in order to more clearly show the initial lymph node location 204.

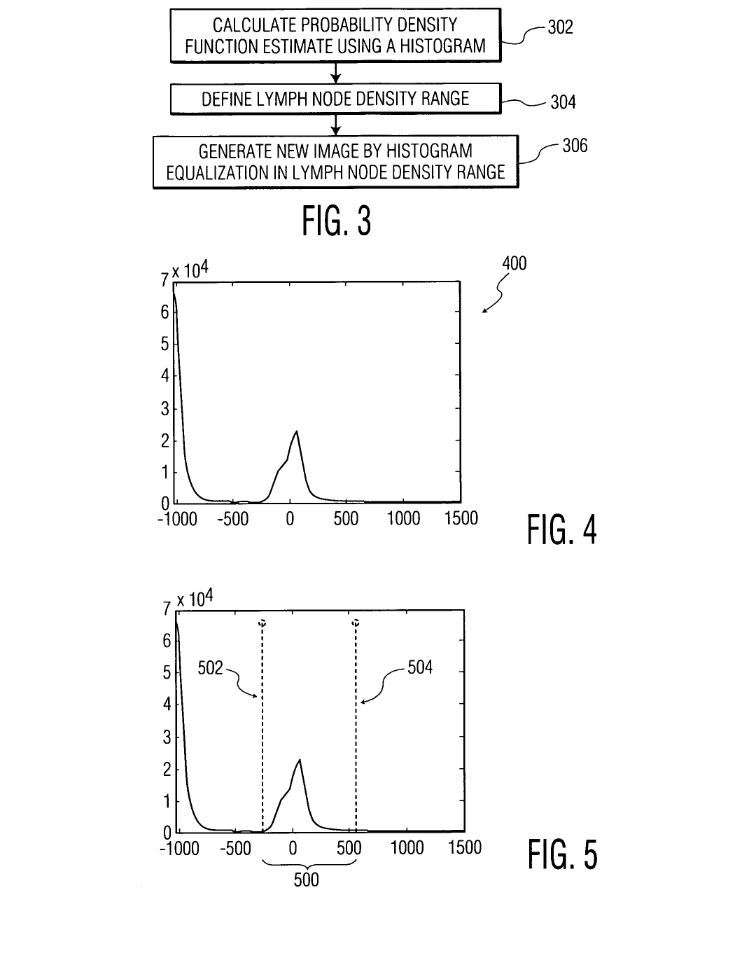

Returning to FIG. 1, at step 104, intensity constraints for the segmentation method are determined based on a histogram analysis of the of the 2D image slice I. This step is described in greater detail by referring to FIG. 3. FIG. 3 illustrates a method for determining intensity constraints based on a histogram analysis according to an embodiment of the present invention. As illustrated in FIG. 3, at step 302, a probability density function estimate of the CT image slice I is calculated using a histogram. The probability density function estimate is the distribution of pixels in the CT image slice I over various densities (i.e., the intensity distribution of the pixels in the CT image slice I). FIG. 4 illustrates a histogram 400 showing the probability density function of the CT image slice 200 of FIG. 2.

Returning to FIG. 3, at step 304, a lymph node density range is defined. The lymph node density range can be defined based on prior knowledge of lymph node densities. For example, prior knowledge based on an investigation of a lymph node database indicates that lymph node densities are typically greater than that of fat (−270 HU) and less than that of bone (600 HU). This range can be shifted slightly upward with contrast-enhanced CT images. FIG. 5 illustrates the lymph node density range 500 on the histogram of FIG. 4. As illustrated in FIG. 5, the lymph node density range 500 is defined by a lower threshold 502 and an upper threshold 504, which are selected based on the prior knowledge of lymph node densities. Accordingly, the lower threshold 502 of the lymph node density range 500 is approximately −270 HU and the upper threshold 504 of the lymph node density range 500 is approximately 600 HU.

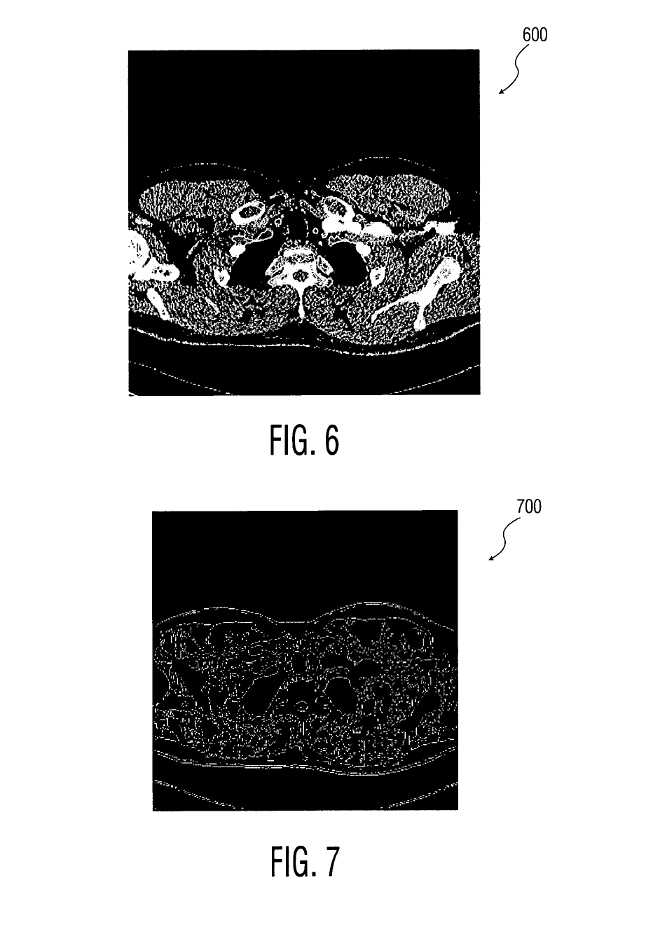

Returning to FIG. 3, at step 306, a new image Iₙ is generated from 1 based on a histogram equalization within the lymph node density range. The new image Iₙ is generated by normalizing the pixel intensity values of I such that the pixel intensities within the lymph node density range are redistributed over the entire intensity range. Pixels having intensity values less than or equal to the lower threshold of the lymph node density range are assigned a minimum intensity value, and pixels having intensity values greater than or equal to the upper threshold of the lymph node density range are assigned a maximum intensity value. The new image Iₙ generated based on the histogram equalization is referred to herein as the “normalized image” Iₙ. The normalized image Iₙ defines the intensity constraints of the segmentation method such that the method only processes image data between within the lymph node density range. FIG. 6 illustrates a normalized image 600 of the CT image slice 200 of FIG. 2. The normalized image of FIG. 6 is generated based on histogram equalization using the histogram 400 of FIG. 4 and the lymph node density range 500 shown in FIG. 5.

Returning to FIG. 1, at step 106, spatial analysis of the segmentation method is performed based on an edge analysis of the normalized image Iₙ. In order to determine the spatial analysis, edge detection is performed on the normalized image Iₙ. For example, edge detection can be performed on the normalized image Iₙ using the well-known Canny edge detection method, but the present invention is not limited thereto. Once the edge detection method is performed on the normalized image Iₙ, the edge strength of pixels with intensities at the upper and lower thresholds of the lymph node density range can be enhanced by a factor of k (e.g., k=4). This results in an edge map of the normalized image Iₙ. FIG. 7 illustrates an edge map 700 resulting from edge analysis of the normalized image 600 of FIG. 6.

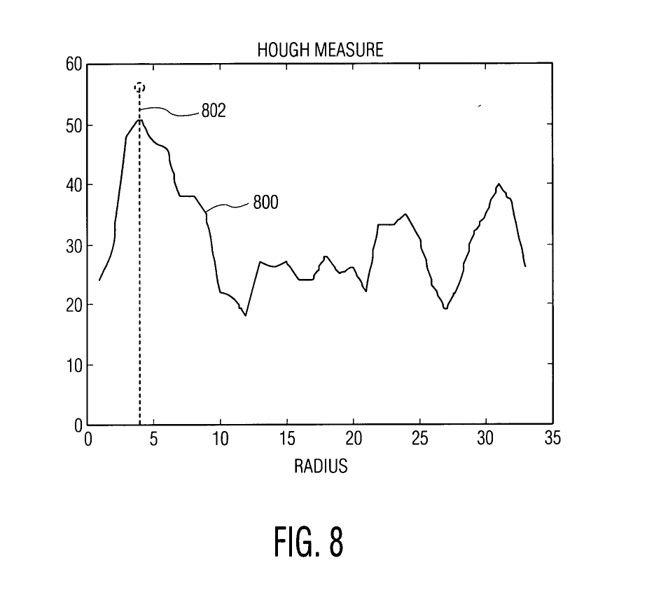

Returning to FIG. 1, at step 108 an initial contour is estimated based on the edge map. The initial contour is a circle centered at the lymph node location (x₀,y₀). This step estimates the initial contour determines a radius r* of this circle. A Hough transform is utilized to determine the radius r*. A Hough transform generates a Hough measure based on the number of intersections of the contour with edges (on the edge map) as the radius of the contour grows. It is also possible to use image information other than edges, such as local region descriptors or different edge descriptors to generate the Hough measure. The radius r* is selected at which the first local maximum in Hough measure occurs. FIG. 8 illustrates the Hough measure 800 as a function of the radius of the initial contour. The value for the radius corresponding to the first local maximum 802 of the Hough function 800 is selected as the radius r* of the initial contour. Thus, the initial contour is generated as a circle with radius r* and center (x₀,y₀). FIG. 9 illustrates an exemplary CT image slice 900 showing the initial contour 902. Image 904 is a zoomed in image of the area surrounding the initial contour 902.

Returning to FIG. 1, at step 110, the initial contour is propagated to define the lymph node boundaries using an evolving elliptical model. The initial contour evolves to determine the boundaries of the lymph node, while constraining the shape of the contour to an ellipse. The propagation of the contour is also constrained by the intensity constraints determined in step 104. A circular contour is not adequate for representing the shape variations of a lymph node. However, an ellipse provides both flexibility and necessary constraints. Accordingly, the initial circle estimates in the step 108 is transformed to an ellipse representation having both radii equal to r*.

On the original CT image slice (i.e., CT image slice 200 of FIG. 2), the elliptical contour is propagated towards the lymph node boundaries with an edge-based term and a region-based term using a piecewise constant mean approximation. This iteratively changes parameters of the ellipse controlling the position (center point) and size (radii) of the ellipse until the ellipse approximates the boundaries of the lymph node. This process is described in greater detail in G. Unal et al., “Semi-Automatic Lymph Node Segmentation in LN-MRI,” In Proc. IEEE Int. Conf. on Image Processing, 2006, which is incorporated herein by reference.

Once the propagation of the ellipse converges, i.e., does not change significantly from iteration to iteration, the iterative process is stopped. The final lymph node boundaries are extracted as the contour points of the final ellipse. The parameters of the final ellipse can be used directly to provide quantitative measurements of the major and minor axes, which are used by radiologists when measuring lymph nodes. The internal region of the defined ellipse defines the pixels within the segmentation of the lymph node.

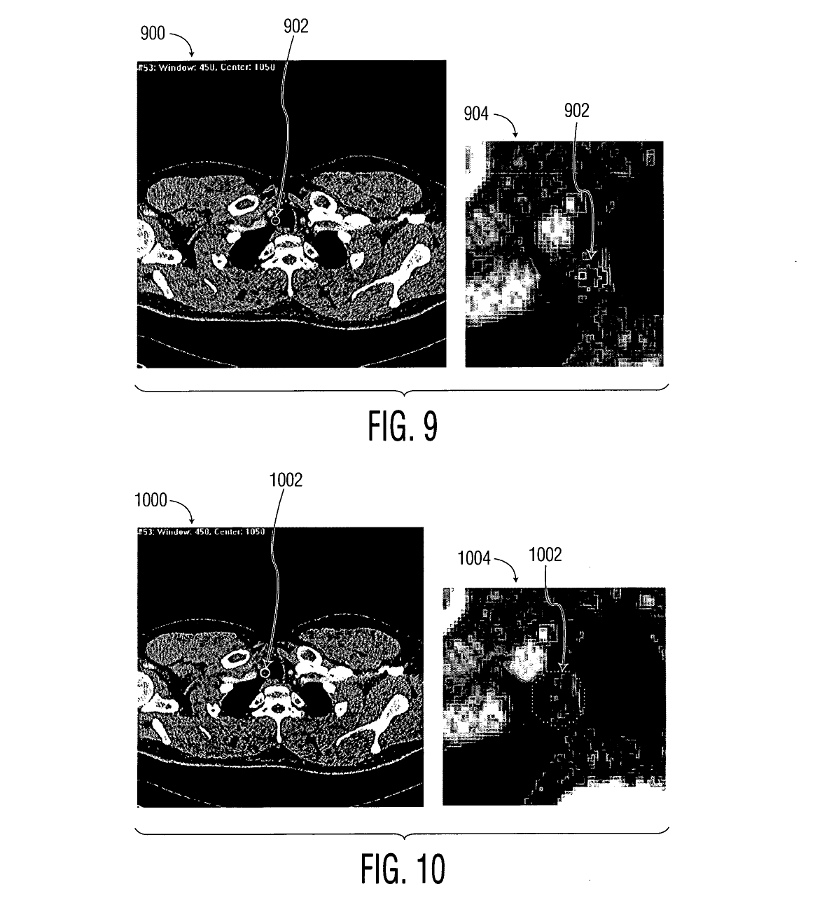

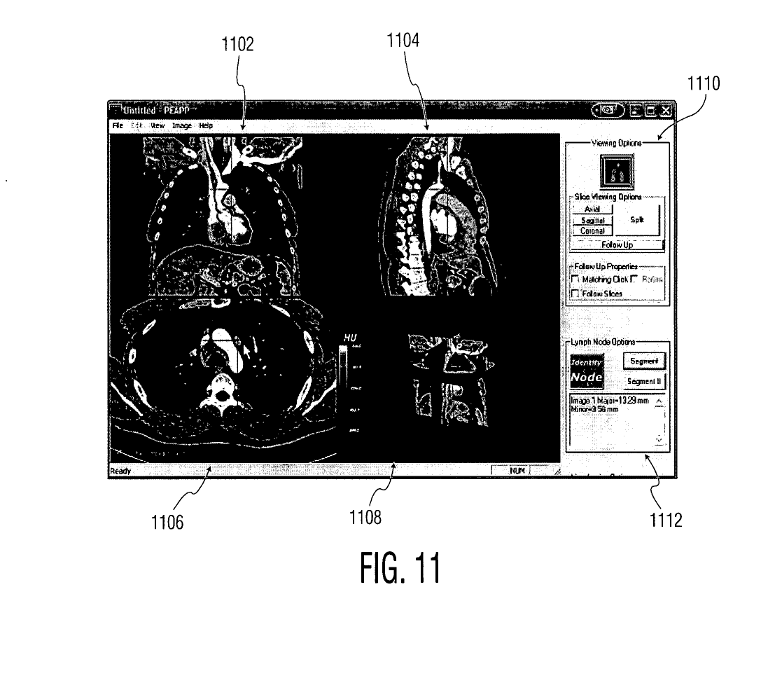

FIG. 10 illustrates exemplary segmentation results. As illustrated in FIG. 10, a lymph node is segmented in a CT image slice 1000. In CT image slice 1000, ellipse 1002 represents the boundary of the segmented lymph node. Image 1004 is a zoomed in image of the area surrounding ellipse 1002 which defines the boundary of the segmented lymph node.

The above described method automatically segments a lymph node given its location using an evolving elliptical contour. The automatic segmentation of lymph nodes, according to embodiments of the present invention, provides a basis for consistent quantitative analysis of lymph node size. Since the parameters of the elliptical contour used for segmentation provide lymph node size measurements, abnormalities due to size can be quickly ascertained. Additionally, since the segmentation identifies particular voxels, intensity based measures for abnormality can be easily assessed. Since radiologists often use size guidelines to determine possible malignancy, these same guidelines can be easily incorporated to automate this process using the size information resulting from the lymph node segmentation.

The above described method can be implemented within a software based CT image analysis system. Such a system can provide carious tools for viewing the image data, as well as annotation tools. FIG. 11 illustrates an exemplary CT image analysis system. As illustrated in FIG. 11, the CT image analysis system displays a coronal view 1102, a sagittal view 1104, a transverse view 1106, and a 3D view 1108 of a contrast-enhanced CT image dataset. The 3D view 1108 is a Multi-Planar Reconstruction (MPR) view in which the coronal, sagittal, and transverse views 1102, 1104, and 1106 are combined. Viewing options 1110 and Lymph node options 1112 for user selection are also displayed. The viewing node options 1110 are used to control the views displayed of the CT image data. The lymph node options 1112 are used to identify and segment lymph nodes as well as to display lymph node information, such as the size parameters of a segments lymph node. Using the lymph node options 1112, a lymph node can be selected. The label for this lymph node is automatically determined, and the measurements of the lymph node are automatically derived from the ellipse provided by the above described method. Lymph node data, such as the label and the measurements is automatically recorded and displayed in the lymph node options 1112.

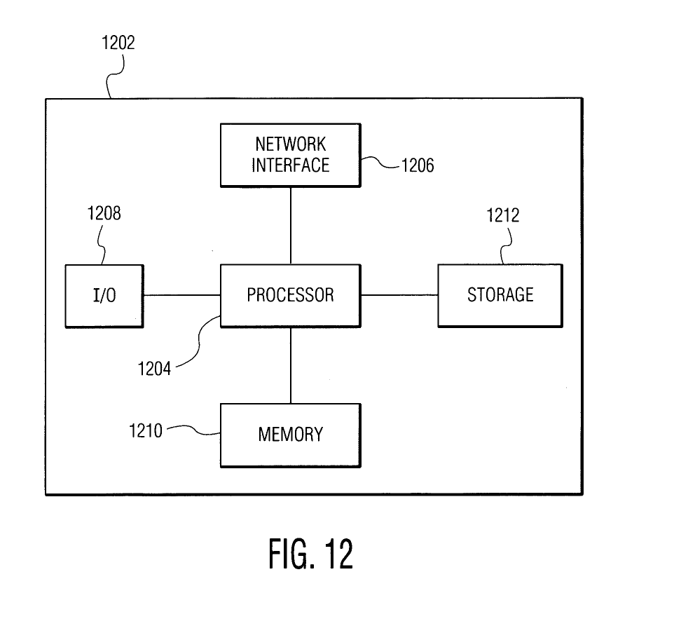

The above-described methods for lymph node segmentation using an evolving elliptical model may be implemented on a computer using well-known computer processors, memory units, storage devices, computer software, and other components. A high level block diagram of such a computer is illustrated in FIG. 12. Computer 1202 contains a processor 1204 which controls the overall operation of the computer 1202 by executing computer program instructions which define such operation. The computer program instructions may be stored in a storage device 1212 (e.g., magnetic disk) and loaded into memory 1210 when execution of the computer program instructions is desired. Thus, an application for segmenting lymph nodes in CT images may be defined by the computer program instructions stored in the memory 1210 and/or storage 1212 and controlled by the processor 1204 executing the computer program instructions. The computer 1202 also includes one or more network interfaces 1206 for communicating with other devices via a network. The computer 1202 also includes other input/output devices 1208 that enable user interaction with the computer 1202 (e.g., display, keyboard, mouse, speakers, buttons, etc.) One skilled in the art will recognize that an implementation of an actual computer could contain other components as well, and that FIG. 12 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for segmenting a lymph node in a CT image based on an input lymph node location in a CT image slice of said CT image, comprising:
determining intensity constraints based on a histogram of the CT image slice;
estimating an initial contour at said lymph node location in said CT image slice; and
propagating said initial contour using an evolving elliptical model that is constrained by said intensity constraints to define a boundary of said lymph node.

2. The method of claim 1, further comprising:
receiving said input lymph node location as a user input.

3. The method of claim 1, further comprising:
performing spatial analysis of the CT image slice using edge detection based on said intensity constraints.

4. The method of claim 3, wherein said step of estimating an initial contour comprises:
estimating said initial contour based on said spatial analysis of the CT image slice.

5. The method of claim 3, wherein said step of determining intensity constraints comprises:
calculating a probability density function estimate of said CT image slice using said histogram;
defining a lymph node density range based on prior knowledge of lymph node densities; and
generating a normalized image from said CT image slice by histogram equalization within said lymph node density range.

6. The method of claim 5, wherein said step of performing spatial analysis comprises:
generating an edge map of said normalized image by detecting edges in said normalized image.

7. The method of claim 6, wherein said step of performing spatial analysis further comprises:
enhancing edge strength of pixels in said edge map having corresponding intensities in said normalized image at upper and lower thresholds of said lymph node density range.

8. The method of claim 6, wherein said initial contour is a circle having a center at said lymph node location and said step of estimating an initial contour comprises:
determining a radius of said initial contour based on said edge map.

9. The method of claim 8, wherein said step of determining a radius of said initial contour based on said edge map comprises:
generating a Hough measure based on the number of intersections of said initial contour with edges on the edge map as the radius of said initial contour varies; and
selecting a radius for said initial contour for which said Hough measure is at a first local maximum.

10. The method of claim 1, wherein said initial contour is a circle centered at said lymph node location and said step of propagating said initial contour comprises:
representing said initial contour as an ellipse;
iteratively propagating the ellipse towards the boundary of the lymph node until the ellipse converges; and
defining the boundary of the lymph node as a final ellipse at the point of convergence.

11. The method of claim 10, further comprising:
storing parameters of said final ellipse.

12. An apparatus for segmenting a lymph node in a CT image based on an input lymph node location in a CT image slice of said CT image, comprising:
means for determining intensity constraints based on a histogram of the CT image slice;
means for estimating an initial contour at said lymph node location in said CT image slice; and
means for propagating said initial contour using an evolving elliptical model to define a boundary of said lymph node.

13. The apparatus of claim 12, further comprising:
means for receiving said input lymph node location as a user input.

14. The apparatus of claim 12, wherein said means for determining intensity constraints comprises:
means for calculating a probability density function estimate of said CT image slice using said histogram;
means for defining a lymph node density range based on prior knowledge of lymph node densities; and
means for generating a normalized image from said CT image slice by histogram equalization within said lymph node density range.

15. The apparatus of claim 14, further comprising:
means for detecting edges in said normalized image to generate an edge map of said normalized image.

16. The apparatus of claim 15, wherein said initial contour is a circle having a center at said lymph node location and said means for estimating an initial contour comprises:
means for determining a radius of said initial contour based on said edge map.

17. The apparatus of claim 16, wherein said means for determining a radius of said initial contour based on said edge map comprises:
means for generating a Hough measure based on the number of intersections of said initial contour with edges on the edge map as the radius of said initial contour varies; and
means for selecting a radius for said initial contour for which said Hough measure is at a first local maximum.

18. The apparatus of claim 12, wherein said initial contour is a circle centered at said lymph node location and said means for propagating said initial contour comprises:
means for representing said initial contour as an ellipse; and
means for iteratively propagating the ellipse towards the boundary of the lymph node until the ellipse converges, wherein a final ellipse at the point of convergence defines the boundary of the lymph node.

19. The apparatus of claim 18, further comprising:
means for storing parameters of said final ellipse.

20. A computer readable medium encoded with computer executable instructions for segmenting a lymph node in a CT image based on an input lymph node location in a CT image slice of said CT image, the computer executable instructions defining steps comprising:
determining intensity constraints based on a histogram of the CT image slice;
estimating an initial contour at said lymph node location in said CT image slice; and
propagating said initial contour using an evolving elliptical model that is constrained by said intensity constraints to define a boundary of said lymph node.

21. The computer readable medium of claim 20, wherein the computer executable instructions defining the step of determining intensity constraints comprise computer executable instructions defining the steps of:
calculating a probability density function estimate of said CT image slice using said histogram;
defining a lymph node density range based on prior knowledge of lymph node densities; and
generating a normalized image from said CT image slice by histogram equalization within said lymph node density range.

22. The computer readable medium of claim 19, further comprising computer executable instructions defining the step of:
generating an edge map of said normalized image by detecting edges in said normalized image.

23. The computer readable medium of claim 22, wherein said initial contour is a circle having a center at said lymph node location and the computer executable instructions defining the step of estimating an initial contour comprise computer executable instructions defining the step of:
determining a radius of said initial contour based on said edge map.

24. The computer readable medium of claim 23, wherein said the computer executable instructions defining the step of determining a radius of said initial contour based on said edge map comprise computer executable instructions defining the steps of:
generating a Hough measure based on the number of intersections of said initial contour with edges on the edge map as the radius of said initial contour varies; and
selecting a radius for said initial contour for which said Hough measure is at a first local maximum.

25. The computer readable medium of claim 20, wherein said initial contour is a circle centered at said lymph node location and the computer executable instructions defining the step of propagating said initial contour comprise computer executable instructions defining the steps of:
representing said initial contour as an ellipse;
iteratively propagating the ellipse towards the boundary of the lymph node until the ellipse converges; and
defining the boundary of the lymph node as a final ellipse at the point of convergence.
